(19) United States
(12) Patent Application Publication
(10) Pub. No.: US 2022/0271528 A1
(43) Pub. Date: Aug. 25, 2022

(54) ELECTRICAL INTERLOCK SYSTEM FOR SWIMMING POOLS

(71) Applicant: DANIEL FARRINGTON, SATELLITE BEACH, FL (US)

(72) Inventor: DANIEL FARRINGTON, SATELLITE BEACH, FL (US)

(21) Appl. No.: 17/650,257

(22) Filed: Feb. 8, 2022

Related U.S. Application Data
(60) Provisional application No. 63/200,198, filed on Feb. 20, 2021.

(51) Int. Cl. H02H 7/08; C02F 1/68; C02F 1/00; E04H 4/12; E04H 4/16

(52) U.S. Cl. CPC H02H 7/0833; C02F 1/685; C02F 1/008; E04H 4/1245; E04H 4/1281; E04H 4/16; C02F 2103/42

(57) ABSTRACT

The Electrical Interlock System (EIS) for Swimming Pools provides the interconnection of the chemical feeders, main pool pump and flow rate in order to meet the government regulatory requirements. The EIS will have the ability to determine if the main pool pump is on, adequate water flow is present and vacuum pressure is within limits. In addition the EIS will provide GFCI protection regardless of electrical manufacturer and pool equipment manufacturer. Based on these conditions, the EIS will provide power to the main pool pump and chemical feeders or disconnect power as required.

### BACKGROUND

Current Florida Health Department regulations as described in Chapter 64E-9 require the following:
The booster pump for chemicals shall be maintained as electrically interlocked with the recirculation pump to prevent the feeding of chlorine when the recirculation pump is not operating.
Feeders for pH adjustment shall have an electrical interlock with the circulation pump to prevent discharge when the recirculation pump is not operating.
Hypohalogenation: An electrical feeder, when used, has electrical interlock with the recirculation pump to prevent the disinfectant from siphoning or feeding directly into the pool or pool piping under any type failure of the recirculation equipment. A flow sensor controller may be used.
The recirculation system shall be operated to maintain a minimum of four turnovers of the pool volume per day (once per 6 hours).

The 2020 National Electric Code (NEC) requires the following:
680.21(C) GFCI Protection—Outlets supplying all pool motors on branch circuits rated 150 volts or less to ground and 60 amperes or less, single- or 3-phase, shall be provided with ground-fault circuit-interrupter protection.
680.21(D) Pool Pump Motor Replacement— Where a pool pump motor in 680.21(C) is replaced for maintenance or repair, the replacement pump motor shall be provided with ground-fault circuit-interrupter protection.
110.3(B) Installation and Use— Equipment that is listed and/or labeled must be installed and used per instructions in the listing or labeling requirements.

A Proposed Rule by the Energy Department on Sep. 11, 2018 states the following:
Dedicated Purpose Pool Pumps (DPPP) shall be replaced by variable-speed control DPPP starting in July 2021. Furthermore, all new installations for DPPP shall be variable-speed control. The variable-speed control DPPP have the option of turning the pump on and off at the pump itself as well as being able to reduce the RPMs of the motor to zero all without loosing voltage to the pump.

Virginia Graeme Baker Pool and Spa Safety Act and Florida Statutes Chapter 514 require the following:
A public swimming pool or spa must be equipped with an anti-entrapment system or device which includes an automatic pump shut-off system. Virginia Graeme Baker was a seven-year-old girl who drowned when she was trapped underwater by the powerful suction of a hot tub drain. Consequently, the Virginia Graeme Baker Pool & Spa Safety Act (P&SS Act) was enacted by Congress and signed by President George W. Bush on Dec. 19, 2007. Designed to prevent the tragic and hidden hazard of drain entrapments and eviscerations in pools and spas, the law became effective on Dec. 19, 2008.

These regulations and requirements demand a system that will provide an electrical interlock among the various components comprising the pool system.

### DETAILED DESCRIPTION

The intelligence of the Electrical Interlock System for Swimming Pools (EIS) is the programmable microprocessor. The microprocessor is capable of monitoring various inputs and controlling the pool equipment based on the following: main pool pump motor amps, flow rate, vacuum pressure and ground faults. The microprocessor can be configured to accommodate any size pool pump motor, pool piping size and multiple pool pump motors.

The former way of simply monitoring voltage to the main pool pump is no longer effective due to the mandate for variable speed pumps. Therefore, a current transducer will monitor the main pool pump amperage in order to determine if it is online. The flow sensor and vacuum sensor will provide information to the microprocessor to determine if there is adequate flow rate or high vacuum pressure which in turn will shut down the chemical feeders and main pool pump as required. The EIS meets the requirements for the Health Department, NEC, Virginia Graeme Baker Pool and Spa Safety Act and Florida Statutes Chapter 514

The EIS also monitors the main pool pump and vacuum pump for ground faults via a residual current monitor sensor thereby providing GFCI protection required by NEC 2020. This GFCI protection is provided regardless of the pool pump motor manufacturer, size (HP) of the pool pump motor and manufacturer of the electrical gear supplying power to the pool pump motor. Procuring and installing a GFCI circuit breaker is no longer needed thereby simplifying maintenance and installations.

Automatic chemical feeder manufacturer installation instruction also requires the chemical feeders to be both interlocked to the flow rate and the main pool pump, and the NEC requires installers to follow the manufacturer installation instructions.

The EIS will also provide a safe and effective means to turn the system off and on for maintenance by providing on/off selector switches for the main pool pump and the vacuum pump. In most of the existing pool systems, the pool technician has to use the circuit breaker to turn the main pool pump on and off.

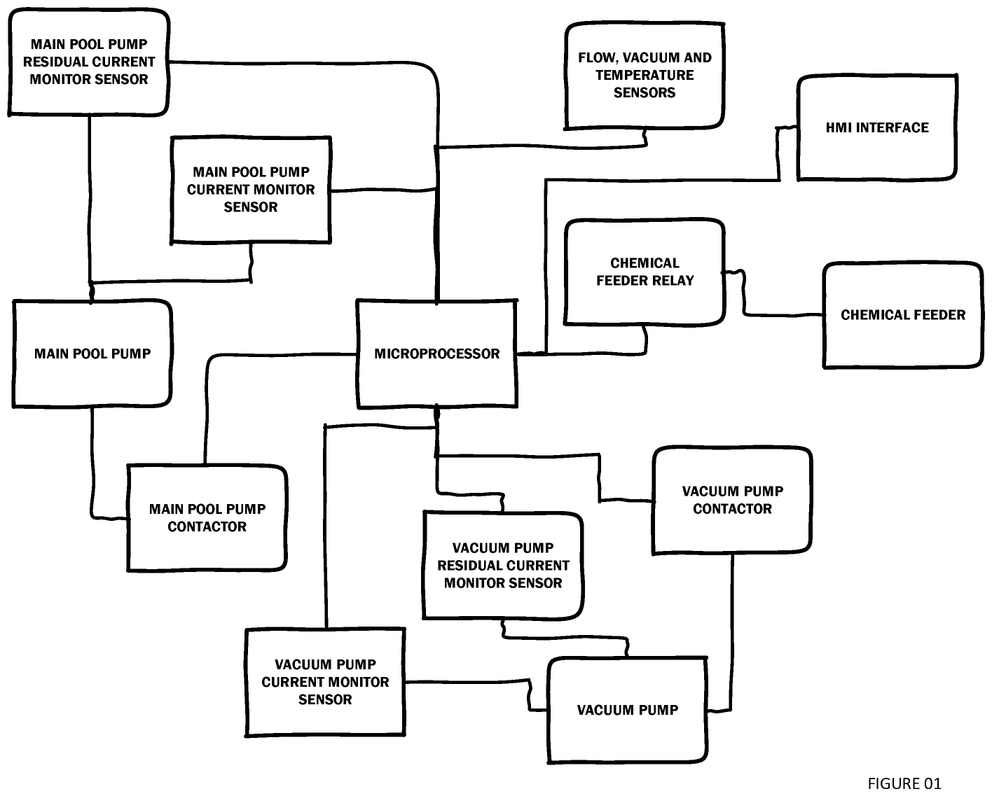

The EIS has WIFI connectivity providing the ability to send outbound information as well as allowing for remote monitoring. The EIS uses relays and contactors to turn equipment on and off based on the inputs from the environment as previously described. It will be in a self-contained enclosure rated for the environment where installed with terminal connections for the main pool pump, vacuum pump, chemical feeder, sensors and power input for the EIS. There will also be a HMI component that will allow users to see real time data comprising of motor amps, GPM, vacuum pressure, etc. Errors and system information can also be logged and stored for historical data and reporting. The various features and components described herein are depicted in FIG. 1.

1. An electrical interlock system comprising:
a. A microprocessor,
b. A flow sensor,
c. A temperature sensor,
d. A power supply,
e. A contactor having the proper sizing for main pump motor load,
f. A contactor having the proper sizing for the vacuum pump motor load,
g. A latching relay having the proper sizing for the chemical feeders,
h. A vacuum pressure sensor,
i. An HMI interface having the ability to display information on a LED screen,
j. A residual current monitor sensor for the main pool pump,
k. A residual current monitor sensor for the vacuum pump,
l. A current transducer sensor for the main pool pump,
m. A current monitor sensor for the main pool pump, and
n. A current monitor sensor for the vacuum pump.

2. The electrical interlock system as claimed in claim 1, wherein the contactor for the main pool pump will turn off the main pool pump when the residual current monitor sensor is out of range.

3. The electrical interlock system as claimed in claim 1, wherein the contactor for the vacuum pump will turn off the vacuum pump when the residual current monitor sensor is out of range.

4. The electrical interlock system as claimed in claim 1, wherein the contactor for the main pool pump will turn off the main pool pump when the vacuum pressure sensor is out of range.

5. The electrical interlock system as claimed in claim 1, wherein the relay for the chemical feeders will turn off the chemical feeders when the main pool pump is turned off.

6. The electrical interlock system as claimed in claim 1, wherein the relay for the chemical feeders will turn the chemical feeders off when the current monitor sensor for the main pool pump is out of range.

7. The electrical interlock system as claimed in claim 1, wherein the relay for the chemical feeders will turn the chemical feeders off when the flow sensor is out of range.

8. The electrical interlock system as claimed in claim 1, wherein the system will have WIFI connectivity in order to send outbound notifications comprising of text messages, data to external sites and email.

9. The electrical interlock system as claimed in claim 1, wherein the system will have WIFI connectivity in order to allow for remote access.

10. The electrical interlock system as claimed in claim 1, wherein the HMI interface will display information from the system comprising of temperature, flow rates, vacuum pressure and motor amperes.
